(19) United States
(12) Patent Application Publication
(10) Pub. No.: US 2005/0016795 A1
(43) Pub. Date: Jan. 27, 2005

(54) Modular ladder and tree stand system

(76) Inventor: Timothy S. Skipper, Ormond Beach, FL (US)

Correspondence Address: J. WILEY HORTON, ESQUIRE;Pennington, Moore, Wilkinson, Bell & Dunbar, P.A., Post Office Box 10095, Tallahassee, FL, 32302-2095, US

(21) Appl. No.: 10/727,864

(22) Filed: Dec. 4, 2003

Related U.S. Application Data
(60) Provisional application No. 60/490,102, filed on Jul. 25, 2003.

(51) Int. Cl. E06C 9/00

(52) U.S. Cl. 182/100

(57) ABSTRACT

A portable modular ladder which can be attached to a vertical object to be climbed—such as a tree. The ladder's structure is preferably provided by two or more vertical support columns locked together. These vertical support columns can be secured to the object to be climbed by a securing strap or other conventional means. A set of rungs extend outward from the vertical support columns. The invention also includes an offset tree stand configured to be attached to the top of the vertical support columns. Once attached, the tree stand and ladder become one integral unit. This feature allows the vertical support columns and tree stand to be assembled on the ground, then pivoted up against the tree. The user can then secure the ladder to the tree as he or she climbs.

### CROSS-REFERENCES TO RELATED APPLICATIONS

This application is a non-provisional application claiming the benefit, pursuant to 37 C.F.R. § 1.53 (c), of an earlier filed provisional application. The provisional application listed the same inventor. The requisite information as to the provisional application is as follows:

| Application Serial Number | Filing Date |
|---|---|
| 60/490,102 | Jul. 25, 2003 |

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of ladders and tree stands. More specifically, the invention comprises a modular ladder and hunting tree stand.

2. Description of the Related Art

Modular ladders designed to allow the climbing of vertical objects such as trees are disclosed in several prior U.S. patents. Examples include U.S. Pat. No. 5,040,635 to Strickland (1991); U.S. Pat. No. 6,076,634 to Simon (2000); U.S. Pat. No. 6,170,609 to Dech (2001); and U.S. Pat. No. 6,340,071 to Dickemper (2002).

Likewise, tree stands allowing a hunter to remain in an elevated position are widely known. Examples include U.S. Pat. No. 5,097,925 to Walker, Jr. (1992); U.S. Pat. No. 5,862,883 to Carriere (1999); and U.S. Pat. No. 6,246,000 to Johnson (2001).

### BRIEF SUMMARY OF THE INVENTION

The present invention comprises a portable modular ladder which can be attached to a vertical object to be climbed—such as a tree. The ladder's structure is preferably provided by two or more vertical support columns locked together. These vertical support columns can be secured to the object to be climbed by a securing strap or other conventional means. A set of rungs extend outward from the vertical support columns.

The invention also includes an offset tree stand configured to be attached to the top of the vertical support columns. Once attached, the tree stand and ladder become one integral unit. This feature allows the vertical support columns and tree stand to be assembled on the ground, then pivoted up against the tree. The user can then secure the ladder to the tree as he or she climbs.

### BRIEF DESCRIPTION OF THE SEVERAL VIEWS OF THE DRAWINGS

FIG. 1 is an isometric view, showing a vertical support column.

FIG. 2 is a detail view of the object shown in FIG. 1

FIG. 3 is an isometric view, showing the addition of a securing strap.

FIG. 4 is a detail view, showing how the securing strap is attached

FIG. 5 is an isometric view, showing how the vertical support column attaches to a tree.

FIG. 6 is a perspective view, showing an offset tree stand.

FIG. 7 is a perspective view, showing an offset tree stand.

FIG. 8 is a perspective view, showing an offset tree stand attached to a vertical support column.

FIG. 9 is a perspective view, showing an offset tree stand attached to a series of vertical support columns to form a ladder/stand assembly.

FIG. 10 is a perspective view, showing the erection of the ladder/stand assembly.

FIG. 11 is a perspective view, showing the ladder/stand assembly attached to a tree.

FIG. 12 is a perspective view, showing the ladder/stand assembly attached to a tree.

### REFERENCE NUMERALS IN THE DRAWINGS

| | | | |
|---|---|---|---|
| 10 | tree | 18 | securing top |
| 20 | standoff | 26 | inclined hole |
| 30 | strap lock | 96 | vertical support column |
| 100 | extension | 102 | receptacle |
| 110 | firsat wall | 112 | second wall |
| 130 | third wall | 132 | fourth wall |
| 144 | hook | 180 | offset tree stand |
| 182 | mounting post | 184 | frame |
| 186 | foot rest | 188 | seat |
| 190 | stand off | 192 | ladder/stand assembly |
| 200 | treeward side | 202 | outward side |
| 204 | ladder side | 208 | base standoff |
| 210 | fixed rung | 212 | stand strap |

### DETAILED DESCRIPTION OF THE INVENTION

This invention includes improvements made to my prior designs for modular climbing ladders. These prior designs are disclosed in detail in copending U.S. application Ser. Nos. 10/058,901 and 10/162,002, along with general descriptions of the operation of such devices. These prior copending applications are hereby incorporated by reference.

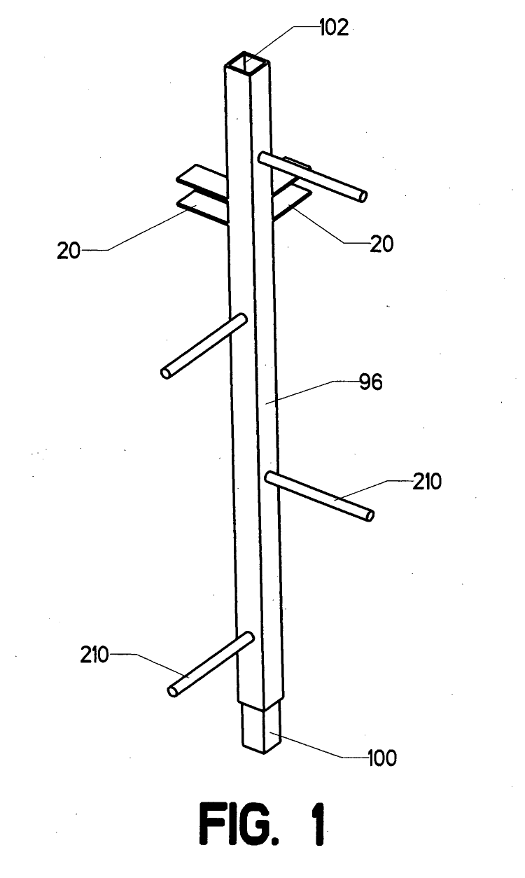

Modular climbing ladders are preferably portable. Thus, it is desirable to break the ladder into a series of shorter sections. FIG. 1 shows the primary structural element of the proposed modular ladder—designated as vertical support column 96. It is made from a length of hollow square stock. The open upper end forms receptacle 102. Extension 102 extends downward from the lower end. Extension 100 is designed to slide into a receptacle 102 on a second vertical support column 96 placed immediately below the one shown. Those skilled in the art will know that many equivalent interconnecting mechanisms could be used. As an example, a larger square sleeve could be substituted for extension 100. This larger sleeve would then slide over the exterior of the upper portion of a vertical support column 96 sitting below the one shown.

Standoffs 20 are provided to separate vertical support column 96 a short distance from the object to which it is attached. The column also includes a set of fixed rungs 210. These project outward from the two walls facing away from standoffs 20.

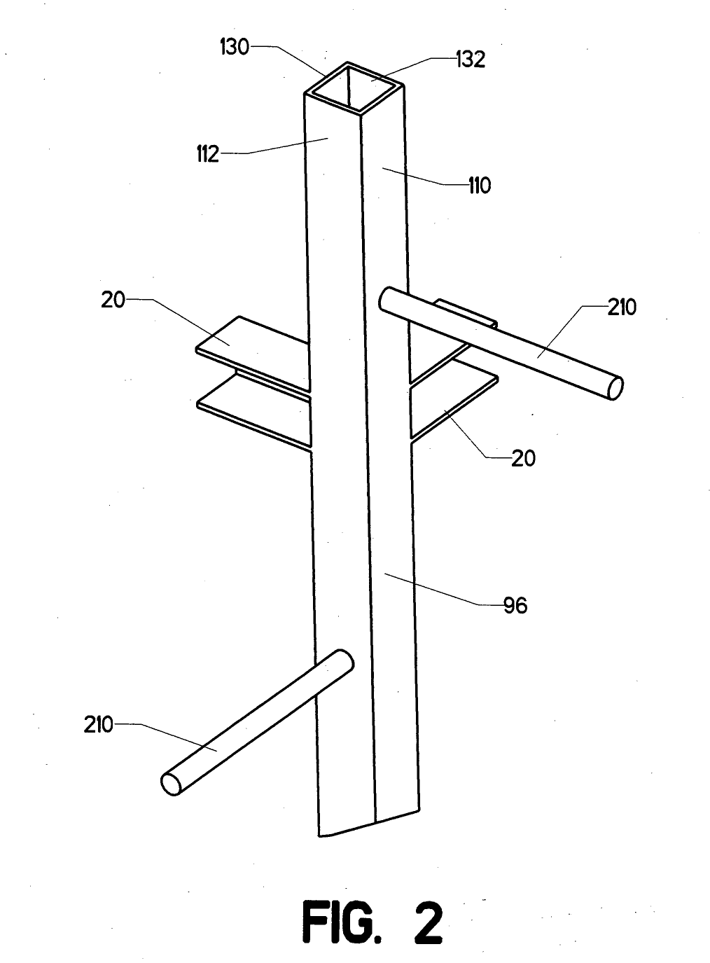

FIG. 2 shows the upper portion of the column in more detail. Being a piece of square hollow stock, the column is comprised of first wall 110, second wall 112, third wall 130, and fourth wall 132. The reader will observe that successive fixed rungs 210 are oriented 90 degrees apart (as opposed to the standard 180 degree spacing found in prior art ladders). The upper fixed rung shown in the view extends from first wall 110, whereas the next fixed rung extends from second wall 112. Fixed rungs 210 are permanently attached, such as by welding. The 90 degree spacing is preferable, since it allows the column to be placed close to the tree—thereby enhancing stability—while still allowing clearance for the forward portion of the user's foot when he or she is standing on a rung. The use of smaller standoffs also consumes less material and makes the overall design more compact.

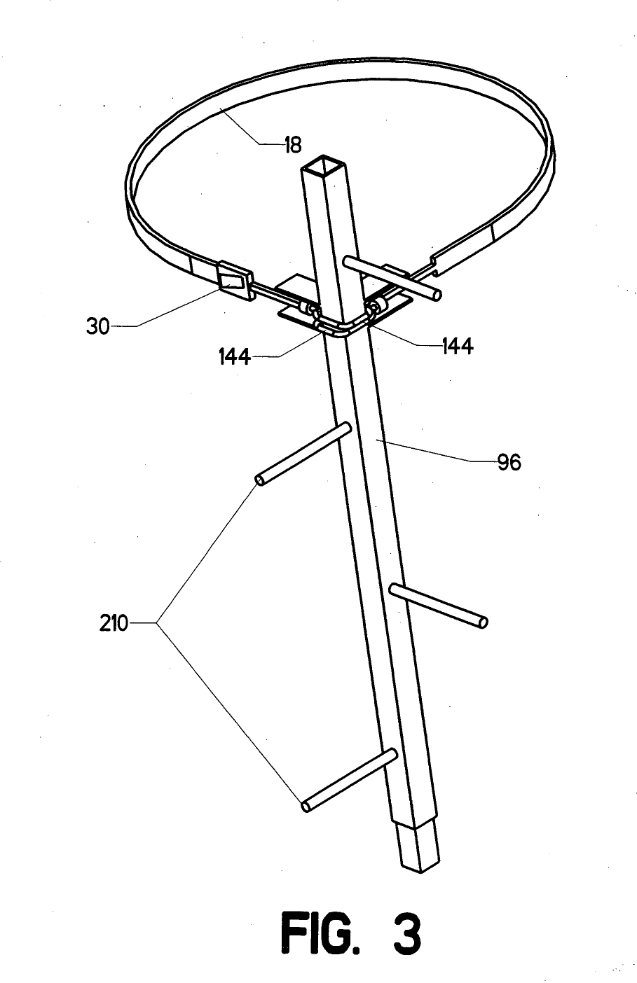

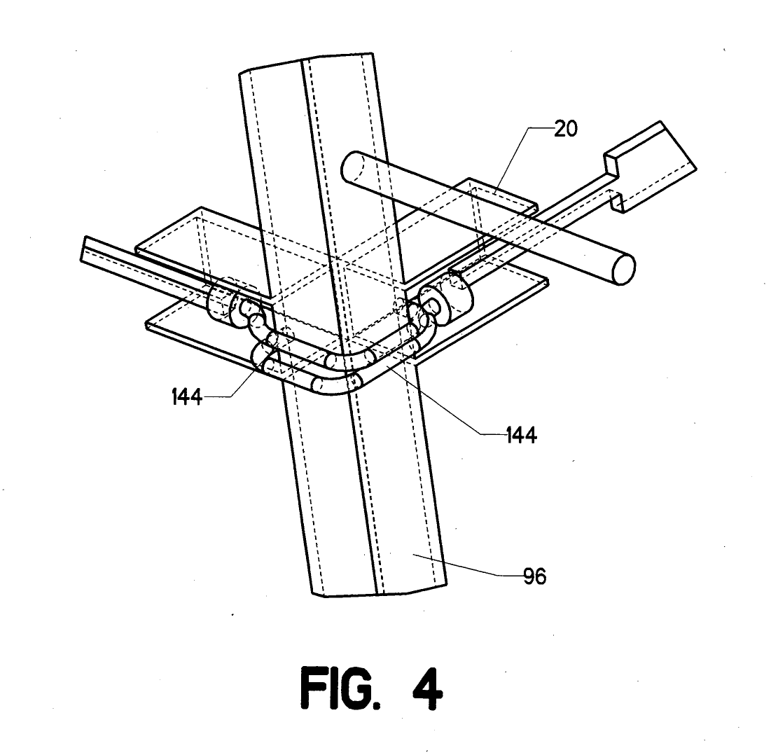

In use, each vertical support column must be attached to the object to be climbed (typically a tree). FIG. 3 shows the addition of securing strap 18 to the column. The two ends of the strap incorporate hooks 144. These are passed around the square section, preferably in the vicinity of the standoffs so that the standoffs will help hold the hooks in place. The overall length of the strap is adjusted by pulling it through strap lock 30. Strap lock 30 can then be cinched in order to maintain the desired length. FIG. 4 shows the attachment of the two hooks 144 in more detail. The two standoffs, preferably being made of “C-channel” tend to hold the hooks in position so that the strap does not slide up and down the column.

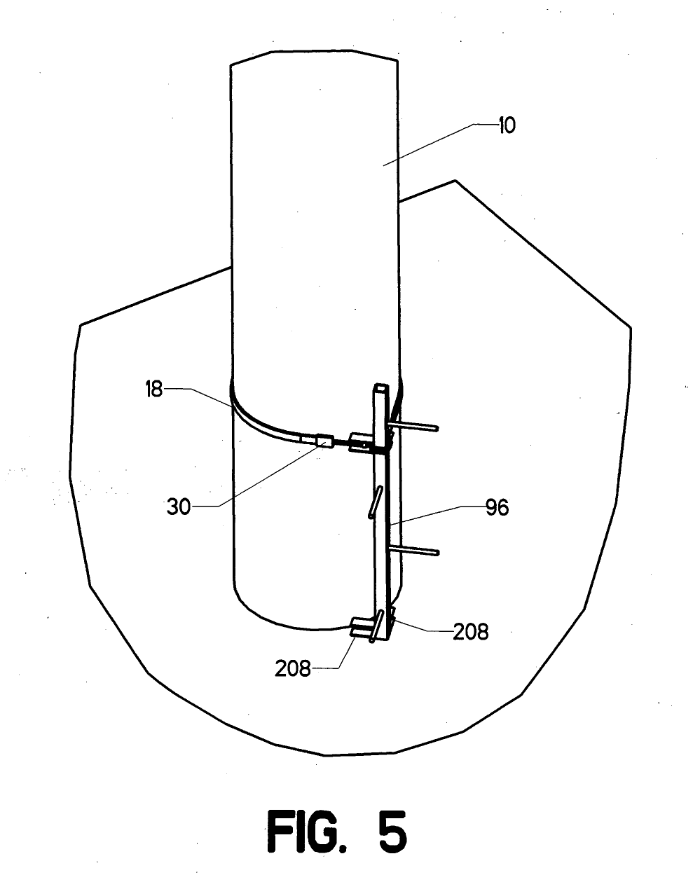

FIG. 5 shows vertical support column 96 attached to tree 10. Securing strap 18 has been passed around the tree, pulled tight, and locked into position by strap lock 30. A second set of standoffs is preferably added to the bottom of the lowest vertical support column 96 used in the ladder (The lowest one is actually shown in FIG. 5). This second set—denoted as base standoffs 208—prevent the column from sinking into the ground and help to orient the column with respect to the tree. The reader will observe how the standoffs prevent the column from being pulled directly against the tree. Those skilled in the art will also realize that the “Vee” shape of the two standoffs will rotationally stabilize the column with respect to the tree.

Those skilled in the art will know that a modular ladder is often used with a separate prior art tree stand. Although these two devices are placed in close proximity so that they can be used together, they are not customarily linked. The user typically assembles the ladder on the ground, then places it against the tree and uses the securing straps to attach it. The user must then climb the ladder while carrying the tree stand (typically folded flat). Once the user reaches the top of the ladder, he or she must balance there while unfolding the tree stand, positioning it properly, and securing it to the tree. Considering that the tree stand often weighs twenty to thirty pounds, this operation is both difficult and dangerous. While the vertical support columns forming part of this invention can certainly be used with a separate tree stand, they are also configured to allow the use of an integrated tree stand.

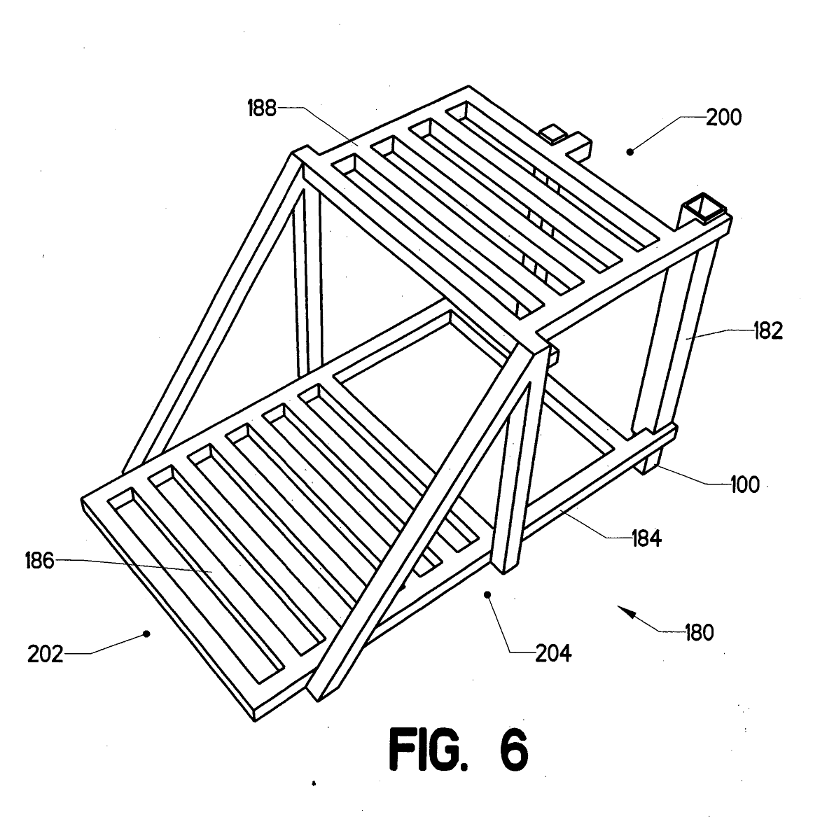

FIG. 6 shows offset tree stand 180, which is designed to be attached directly to the modular ladder. Frame 184 is made of welded square stock, or other known materials (tubing, angle iron, etc.). It incorporates foot rest 186 and seat 188. A swivel seat with a back may be optionally added. A tilting foot rest may also be added. These features are known in the art.

The tree stand has treeward side 200 (which faces the tree), outward side 202 (which faces away from the tree, and ladder side 204 (which faces the ladder). Those skilled in the art will realize that a “flipped” version could be created which would have the ladder side on the opposite side from where it is shown in FIG. 6.

Mounting post 182 is attached to frame 184 near the intersection of the treeward and ladder sides. Extension 100 extends downward from mounting post 182. It is sized to slide into receptacle 102 on the top of a vertical support column 96. Those skilled in the art will know that mounting post 182 and extension 100 could simply be made of one uniform piece of square stock. In such an embodiment, frame 184 would prevent the extension from sliding too far into the receptacle on the top of the vertical support column.

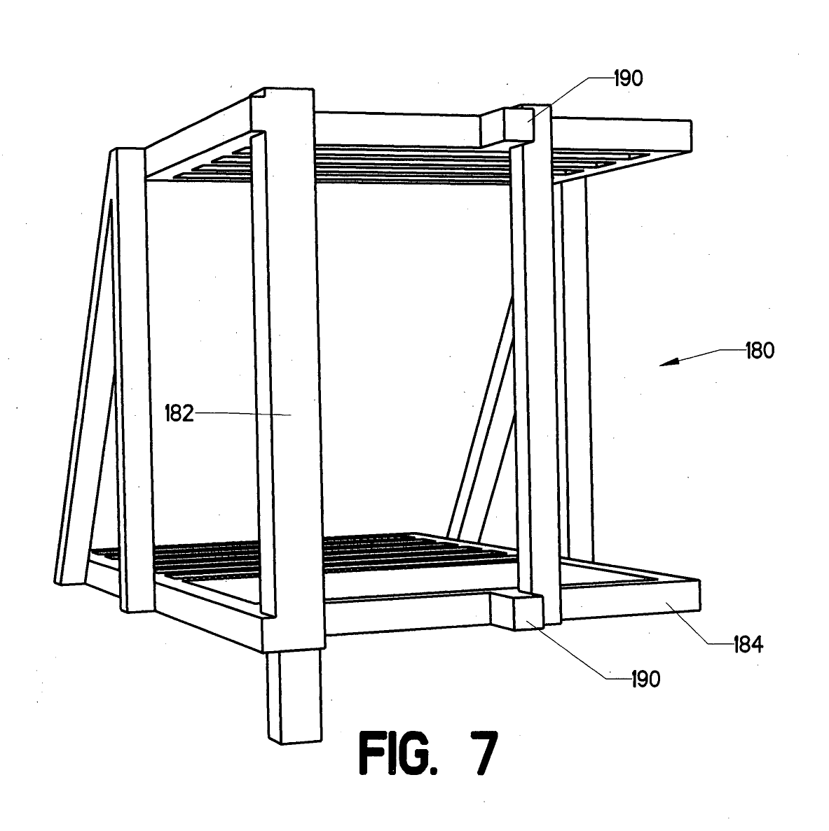

FIG. 7 shows offset tree stand 180 from the treeward side. Two standoffs 190 are provided to space the tree stand out from the tree. Mounting post 182 can serve as an additional standoff. In this view, the reader will observe how the tree stand is offset from the points where it attaches to the tree. In other words, the standoffs do not center the stand on the tree. The purpose for this feature will be explained shortly.

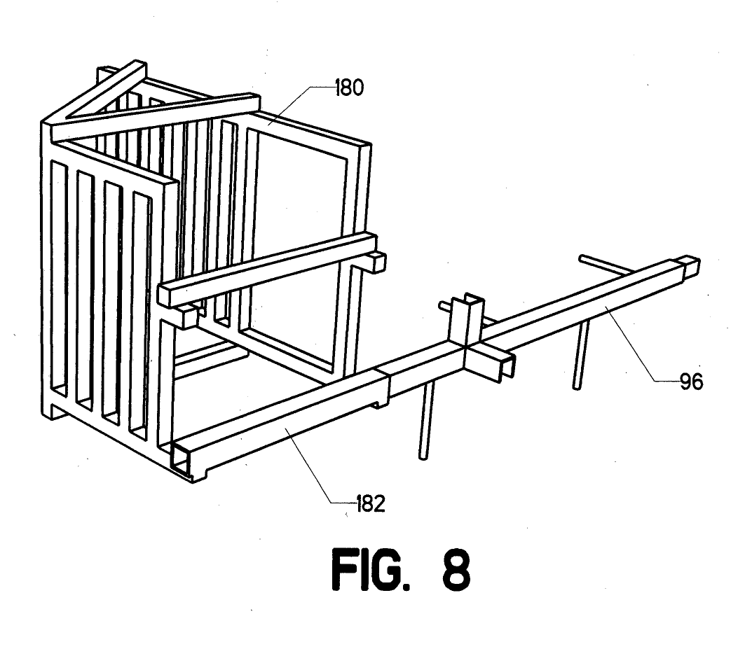

FIGS. 8-12 depict the operation of the modular tree stand and ladder system. The user begins by connecting the components on the ground. FIG. 8 shows offset tree stand 180 being attached to a vertical support column 96 (The version shown has removable rungs, but the assembly is the same for a fixed rung version). This is done by placing extension 100 on the bottom of offset tree stand 180 into receptacle 102 on the top of vertical support column 96. This interface is a fairly close fit. Friction alone—later aided by gravity when the assembly is erected—is generally sufficient to hold the assembly together. However, a locking cross pin or spring-loaded detent can also be used if desired.

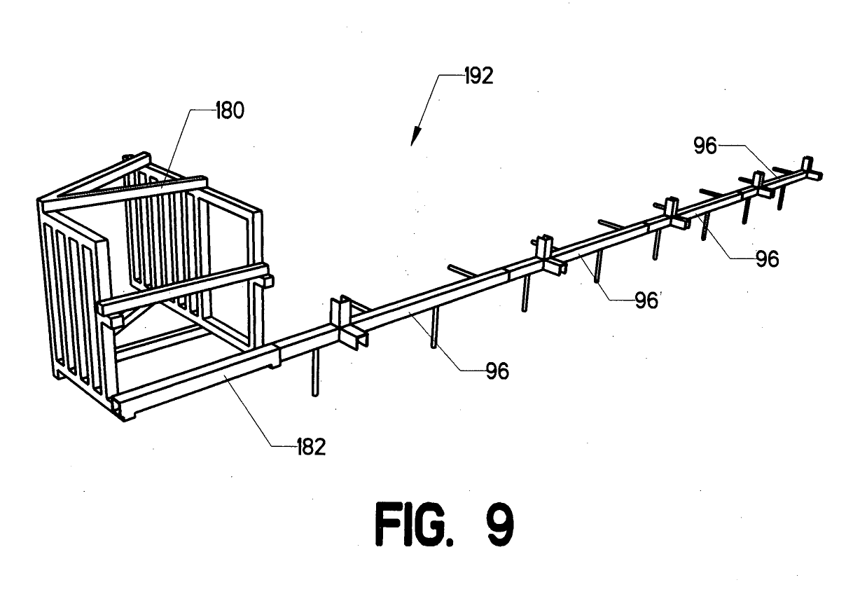

In FIG. 9, three more vertical support columns 96 have been added to the assembly (Of course, the user could just as easily start by assembling the ladder components and add the tree stand last). The user adds vertical support columns until the desired ladder length has been reached, resulting in the formation of ladder/stand assembly 192. The reader will note that a vertical support column 96 having a second sent of offsets near its lower portion has been used in the assembly shown.

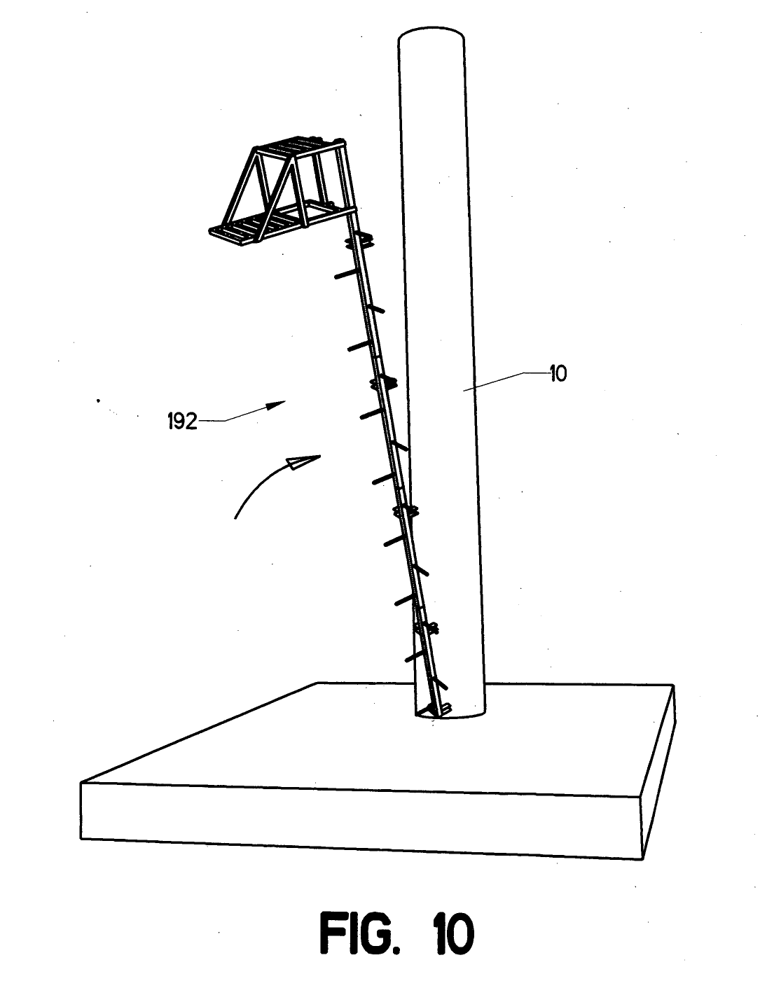

Turning now to FIG. 10, the user places the lowest portion of the lowest vertical support column next to the tree, then pivots the assembly upward as shown. Once the ladder is pressed against the tree, the user adds a securing strap (or similar device) to the lowest vertical support column. With this lowest strap in place, the assembly will be stable against the tree.

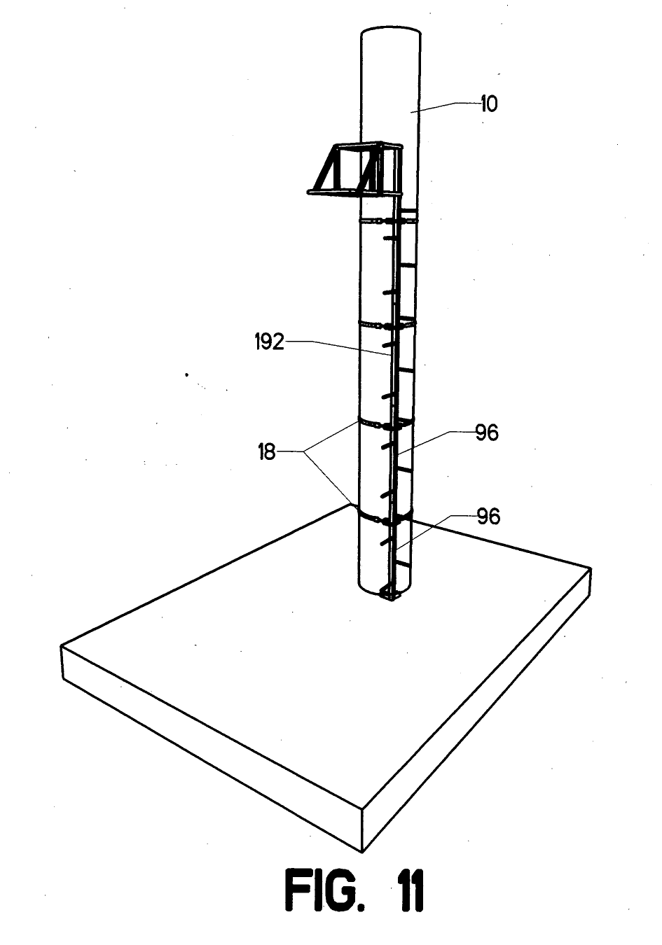

The user next begins climbing the ladder, adding securing straps for each vertical support column he or she reaches. FIG. 11 shows the completed assembly attached to the tree. Each vertical support column has been secured. The ladder structure is sufficient to safely support the tree stand without the need to further lash or attach the tree stand to the tree. Thus, once the user reaches the top, he or she can simply step onto the stand.

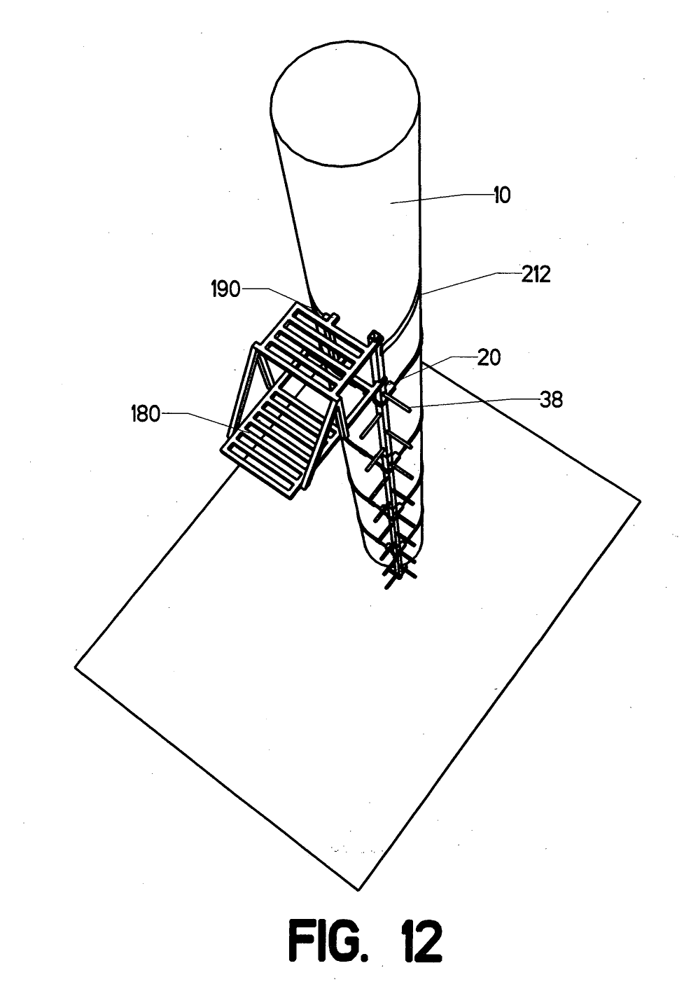

FIG. 12 shows the completed assembly from above. In this view, the reader will appreciate how the offset nature of offset tree stand 180 allows a user to easily climb the ladder and then step over onto the tree stand. If the ladder attached in the middle of the stand, the user would have to swing around the bulk of the stand itself. The user will also note how stand off 190 serves to further stabilize the stand and ladder against the tree. If desired, the user can supplement the strength of the ladder by attaching an additional stand strap 212 securing strap to the tree stand itself This can then be locked in place to provide extra rigidity.

Although the preceding description contains significant detail, it should not be construed as limiting the scope of the invention but rather as providing illustrations of the preferred embodiment of the invention. Thus, the scope of the invention should be fixed by the following claims, rather than by the examples given.

1. An integrated ladder and tree stand for attachment to a tree, comprising:
a. a ladder, including
i. a first vertical support column, having an upper end and a lower end, with a receiver on said upper end;
ii. a second vertical support column, having an upper end and a lower end, with an extension on said lower end and a receiver on said upper end, whereby said second vertical support column can be attached to said first vertical support column by placing said extension on said second vertical support column in said receiver on said first vertical support column;
iii. attachment means for securing said first vertical support column to said tree;
iv. attachment means for securing said second vertical support column to said tree;
v. a plurality of rungs attached to said first and second vertical support columns;
b. a tree stand, including,
i. a frame, having an upper end and a lower end; and
ii. an extension on said lower end, whereby said frame can be attached to said second vertical support column by placing said extension on said frame into said receiver on said upper end of said second vertical support column.

2. An integrated ladder and tree stand as recited in claim 1, wherein:
a. said frame of said tree stand includes a treeward side, an outward side, and a ladder side; and
b. said extension is located proximate said treeward side and said ladder side of said frame, so that when said frame is attached to said second vertical support column, said tree stand is laterally offset from said ladder.

3. An integrated ladder and tree stand as recited in claim 2, wherein said frame further comprises at least one standoff located on said treeward side of said frame.

4. An integrated ladder and tree stand as recited in claim 3, wherein said frame further comprises a vertical mounting post, and wherein said extension extends downward from said vertical mounting post.

5. An integrated ladder and tree stand as recited in claim 1, further comprising attachment means for securing said tree stand to said tree.

6. An integrated ladder and tree stand as recited in claim 1, wherein said frame comprises a foot rest and a seat.

7. A modular ladder for attachment to a tree, comprising:
a. a first vertical support column, including
i. an upper end;
ii. a receiver on said upper end;
iii. a lower end;
iv. a first, second, third, and fourth wall;
v. a first standoff extending from said third wall;
vi. a second standoff extending from said fourth wall;
vii. a first rung extending from said first wall;
viii. a second rung extending from said second wall;
b. a second vertical support column, including
i. an upper end;
ii. a lower end;
iii. an extension on said lower, whereby said second vertical support column can be attached to said first vertical support column by placing said extension on said second vertical support column in said receiver on said first vertical support column;
iv. a first, second, third, and fourth wall;
v. a first standoff extending from said third wall;
vi. a second standoff extending from said fourth wall;
vii. a first rung extending from said first wall;
viii. a second rung extending from said second wall;
c. attachment means for securing said first vertical support column to said tree; and
d. attachment means for securing said second vertical support column to said tree.

8. A modular ladder as recited in claim 7, wherein said first rung extending from said first wall and said second rung extending from said second wall are separated by approximately 90 degrees.
